(19) United States
(12) Patent Application Publication
(10) Pub. No.: US 2015/0221186 A1
(43) Pub. Date: Aug. 6, 2015

(54) Blackjack Variant Game and Method of Play

(71) Applicant: Markman Holdings, LLC, Bethlehem, PA (US)

(72) Inventors: Stephen Berkowitz, Macungie, PA (US); Norman G. Berkowitz, Slatington, PA (US)

(73) Assignee: MARKMAN HOLDINGS, LLC

(21) Appl. No.: 14/574,353

(22) Filed: Dec. 17, 2014

Related U.S. Application Data
(60) Provisional application No. 61/916,952, filed on Dec. 17, 2013.

(51) Int. Cl. G07F 17/32; A63F 1/00

(52) U.S. Cl. CPC G07F 17/3293; A63F 1/00; G07F 17/3244; A63F 2001/003

(57) ABSTRACT

A live or electronically implemented casino game of Blackjack wherein players are afforded an opportunity, by payment of an ante or discard fee in advance of any cards having been dealt, to replace both of the face-up cards in their originally dealt hand with two new face-down cards that are dealt to the players prior to the original hand being dealt and which the players have not seen prior to electing to replacement the original hand with a replacement hand. Where the player elects not to switch hands, the replacement cards are transferred by the dealer to the discard card rack unseen by the players, effectively hindering card counting.

### CROSS REFERENCE TO RELATED APPLICATIONS

This application claims the benefit of the filing date of U.S. Provisional Patent Application Ser. No. 61/916,952 filed on Dec. 17, 2013, the disclosure of which is incorporated herein by reference.

### FIELD OF THE INVENTION

The present invention relates generally to card games and methods of playing card games. More particularly, the present invention is a variant or modified version of the wagering game of Blackjack in the method of play players can elect to substitute their initial hand with a new initial hand, and in addition to a wagering game and method of play that hinders card counting.

### BACKGROUND OF THE INVENTION

Blackjack is one of the most widely played casino table games worldwide. Electronic and online versions of Blackjack are also popular. In conventional casino Blackjack, the game is played with multiple decks and each player is dealt a two-card hand face up. The dealer also receives a two card hand, with one card dealt face up and the other dealt face down. Each player plays against the dealer, or the house, and not against other players. The object of the game is to draw cards that total as close to a total value of twenty-one without going over. Tens, jacks, queens and kings count as a value of ten, aces count as a value of one or eleven, and all other cards count as their numeric face value.

After the initial two cards are dealt, each player is given the option to “stand,” in which case the player is satisfied with the total value of their original two card hand, or to “hit” their hand, in which case the player is dealt at least one additional card in order to increase the total card value. If a player “hits” and his or her total card value totals more than twenty-one, the player “busts” and loses the hand. After each player turn, the dealer is also given the opportunity to “stand” or “hit.” If the dealer “busts” and a player does not, the player wins with any final total card value of less than twenty-one. The player also wins if their total card value is closer to twenty-one than the dealer's total card value. Players are typically paid even money on winning wagers. Where a player and the dealer have the same total card value, this is considered a tie or a “push.” Under conventional rules, where a player's initial hand includes an ace and another card having a value of ten, this is considered “Blackjack” and the player wins three to two on the bet, unless the dealer also has “Blackjack” in which case the game is a “push.”

Each casino also has its particular rule variations based on law or regulation regarding rules of play such as when a player may double down a bet by placing a second wager equivalent to an original wager, whether pairs can be resplit and how many times, whether when splitting aces a player receives only one card on each ace, the option to buy insurance, and the option to surrender. Typically, the dealer must hit on any hand having a total card value value of sixteen or less, and must stand on any hand having a total card value of seventeen or higher. All of these variations affect the inherent house edge or statistical advantage to the casino built into a game.

A drawback associated with conventional Blackjack is that the game can sometimes be beaten by card counting, a strategy by which advantage players attempt to keep track of the number of high and low value cards in each hand. Since statistically high value cards benefit the players more than low value cards, in order to decrease the house edge, players will bet more when the tally indicates that being dealt a high value card is more favorable, and will bet less when the tally indicates that the likelihood of being dealt a low card is higher. While casinos have developed certain countermeasures to try to disrupt or thwart card counting, this requires a great amount of monitoring of player behavior by the dealer or other casino personnel, as well as video surveillance and computer analysis, and is very costly. Another strategy used by players to try to gain an advantage is hole carding, whereby a player attempts to view the dealer's face down card when it is dealt or when the dealer checks for blackjack.

Having knowledge of the dealer's face down card also can affect a players decision making in a manner such that the player advantage is increased.

A number of less conventional variations of Blackjack are known, all of which in general are designed to increase the excitement of and interest in the game. For example, in Spanish 21, the ten cards are removed from the deck, but other rules such as players blackjacks and player 21's always winning, are added. In some game variations, side wagers related to various outcomes, such as when one or both player cards is the same as the cards of the dealer, are available.

U.S. Pat. No. 6,877,746 discloses a Blackjack game in which after the players are dealt their initial hand and the cards are viewed by the player, each player is given an opportunity to hit, stand, split, double down, or exchange one or both cards for a new card. In order to exchange a card, first an additional fee must be paid by placing it in the fee area, after which the next card or cards are dealt to the player out of the card dispensing shoe. Players do not pay the ante to have the opportunity to exchange one or both cards until after their initial hand is dealt. U.S. Patent Application Publication 2009/0045576 also includes a discard option which allows in various embodiments once or both cards from a hand to be discarded. However, the replacement cards are not dealt to the player wishing to discard one or both cards until after the player cards to be discarded are physically placed by the player in a discard box, after which the new cards are dealt directly from the shoe. In both of such variant games, replacement cards are not dealt to the players until after the player is able to examine his original cards. In addition, both the original cards and replacement cards are visible to all of the players, such that card counting in the game is still possible.

### SUMMARY OF THE INVENTION

According to the present invention, a variant Blackjack game method and apparatus is provided in which players are afforded the opportunity preferably by virtue of payment of an ante to discard or replace an undesirable original Blackjack hand in each game with a replacement hand. Moreover, the variation of the method of play of the present invention from conventional Blackjack whereby the replacement hand is placed faced down and if not used is discarded unseen virtually eliminates the possibility and impact of card counting. The present game and method also fulfills the need for a Blackjack variant game that is easy for those familiar with conventional Blackjack to understand, and has all of the advantages of conventional Blackjack while adding one or more variations that add to the overall attractiveness of the game without substantially altering the speed of game play which is attractive to casino operators, and also maintaining a house edge that is acceptable to players, casino operators, and regulators.

According to the present invention, the variant Blackjack game in an exemplary embodiment is played against a gaming establishment with one or more decks of conventional playing cards. In one embodiment, players are given the option to pay an ante for the opportunity to substitute their original Blackjack hand for an unseen replacement hand. In another embodiment, the ante payment is mandatory whereby each player is afforded this opportunity for each hand dealt. The replacement hand is dealt to the players prior to the regular Blackjack hand being dealt. Where the option to switch hand is accepted, the original Blackjack hand is discarded and the two face down replacement cards are turned over. Where the player elects not to switch hand, the to face down replacement cards are picked up by the dealer and discarded unseen by the players.

In one embodiment, players electing to pay a Switch Hands ante receive bonus payouts at 2 to 1 odds for suited blackjacks or colored blackjacks which are not available to players who do not pay switch hands antes. Otherwise, house rules remain the same as to payouts for blackjack, wins, and insurance. House rules apply to card splitting and double down wagers.

The game and method of the present invention have value to both casino operators and players. The value to players is the opportunity to discard an undesirable first two face-up cards or hand for the possibility of a better first two card hand at a nominal fee, normally 20% or less of the blackjack wager, rather than surrendering at a cost of 50% of the wager and sitting out the remainder of the game. The present game therefore keeps players involved longer in each game rather than folding after being dealt a bad, first two face-up cards hand. In addition, the game provides more entertainment value to players by adding to their perceived control over the cards played in each hand and the anticipation as to whether or not the decision to replace a first hand with a new hand resulted in a better hand. Players who have paid the second or replacement hand antes but have chosen to play their two face-up cards rather than the two face-down cards, surrender the two face-down cards to the dealer who places the cards, unseen, in the discard rack without turning over the face-down cards. Up to twelve cards per game are discarded unseen. The advantage to the house is the hindering of card counting since the two face-down cards that have been dealt to eligible players but not actually played are returned to the discard rack, unseen by players or the dealer. The ante discard fee for the opportunity to switch hands always belongs to the house. House advantages are adjusted and balanced by the cost of the ante so as to comply with state gaming regulations.

### BRIEF DESCRIPTION OF THE DRAWINGS

FIG. 1 is a plan view of an exemplary embodiment of a casino table game in accordance with the present invention.

FIG. 2 is a plan view of another exemplary embodiment of a casino table game in accordance with the present invention.

### DETAILED DESCRIPTION OF THE PREFERRED EMBODIMENTS

The following description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. The components in the drawings are not necessarily drawn to scale, the emphasis instead being placed upon clearly illustrating the principles and manner of use of the invention.

The illustrations presented herein are also not meant to be actual views of any particular apparatus for use in administering a wagering game. act or step in a method of administering a wagering game, or component thereof, but are merely idealized representations employed to describe illustrative embodiments. Moreover, in the drawings, like reference numerals designate corresponding parts throughout the several views. Wherever possible, the same reference numbers are used throughout the drawings to refer to the same or like elements of an embodiment.

The terms “gaming,” “gambling,” or the like, refer to activities, games, sessions, rounds, hands, rolls, operations, and other events related to wagering games. Examples of wagering games include: live casino games, such as live card games, dice games, and wheel games; electronic gaming machine games; multi-player electronic gaming machine games; games played on tables that are equipped with electronics to electronically measure or accept wagers, and/or electronically accept cards; and on-line games and other games of chance for which wagers may be placed by a player and payouts awarded. In addition, the words “wager,” “bet,” “bid” or the like, refer to any type of wagers, bets or gaming ventures that are placed on random events, whether of monetary or non-monetary value. Wagers may represent monetary amounts or non-monetary amounts. For example, players may wager, win and lose amounts of value or non-monetary points. Chips, credits, and other items of value, or points of non-monetary value may be issued, purchased, earned, or otherwise dispensed prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game.

Various platforms are contemplated that are suitable for implementation of embodiments of wagering games according to the present disclosure. For example, wagering games may be implemented on a live gaming table, which may include physical game elements such as physical cards, physical chips, an automatic card handling device, a card dispensing shoe, a no-peek device, or a dealer instruction display, and may include a live dealer. More specifically, a live dealer may deal physical cards, accept wagers, issue payouts, accept elections, combine wagers, take wagers and perform other administrative functions of game play.

Some embodiments may be implemented on electronic devices enabling electronic gaming features, such as providing electronic displays for display of virtual cards, virtual chips, game instructions, pay tables, game outcomes, credit balances, play options, etc. Exemplary electronic devices are adapted for single players or for multiple players to engage in the same game. Other embodiments may include features that are a combination of physical and electronic features. Yet other embodiments are implemented for on-line, web-based play.

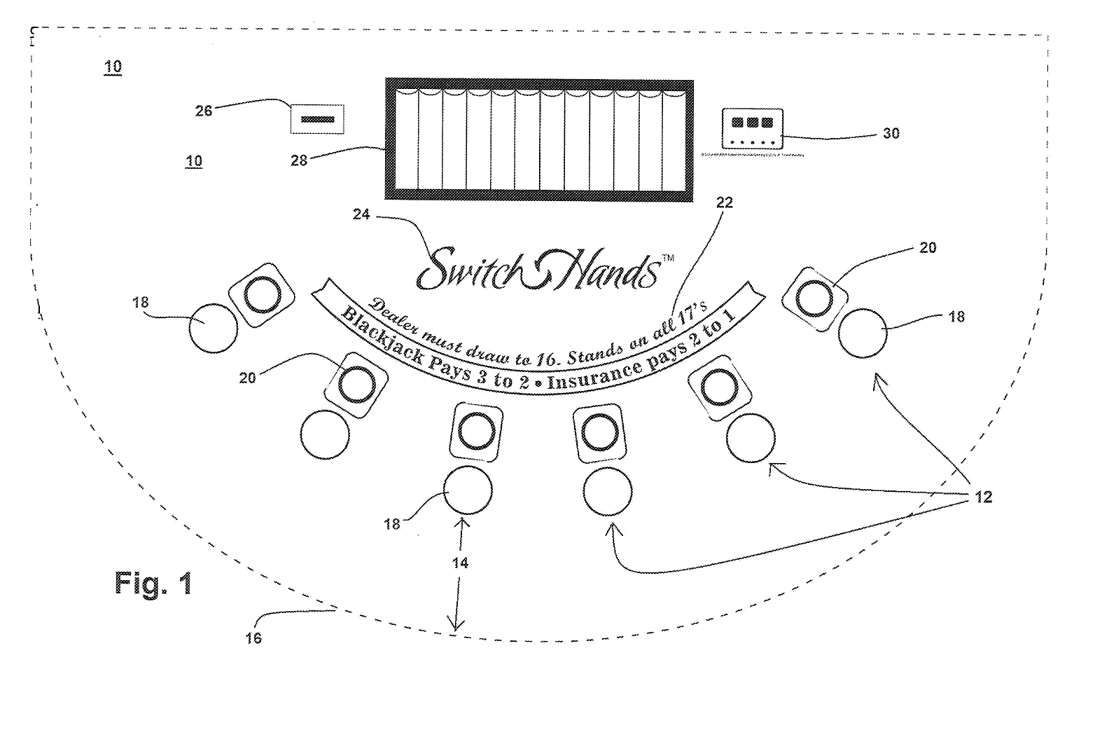

FIG. 1 illustrates an exemplary game playing layout 10 for use on a gaming table in accordance with the game and method of play of the present invention. Playing surface 10 includes a plurality of player betting stations or positions 12 which are evenly spaced apart on the playing surface 10 and oriented generally facing the same side of the table. Each player betting station 12 is adapted for individual game play by a player. An open area 14 with no markings extends generally between the player betting stations 12 and a side edge 16 of the playing surface 10, in which area 14 the players can rest their forearms and place their stack of chips or the like during game play.

Each player betting station 12 includes a first betting circle 18 in which a player places his or her wager to bet on individual Blackjack hands. Positioned directly adjacent to or above betting circle 18 is an ante or replacement card fee payment area 20. In the exemplary embodiment, ante payment area 20 includes an electronic sensor or indicator that is illuminated when an ante payment or discard option fee is placed in the ante payment area 20. As discussed below, the ante or discard option fee must be paid by the player in order for the player to be eligible for the option to exchange the player's originally dealt hand for a replacement hand according to the methods of play described herein.

Also positioned extending generally across the center of the game layout above the player stations 12 is a sweeping ribbon 22. Ribbon 22 is intended as an area where one or more basic game rules such as that the “Dealer must draw to 16. Stands on all 17's”, “Blackjack pays 3 to 2”, and “Insurance pays 2 to 1” are made evident to all of the players at any of the player stations 12. In addition, a logo 24 identifying the game is positioned above ribbon 22. A slot 26 in the game surface connecting to a drop box is located along the dealer side of the table in which payments made to the dealer for additional game chips are placed. A tip box may also be provided in the same manner on the opposite side of the dealer in an approved location, a chip rack 28 is positioned centrally on the dealer side of the table, and a discard rack will be attached to the dealer side of the table in an approved position. In addition, an electronic control panel 30 by which the dealer controls and resets the electronic indicator in second designated area 20 is also provided in the exemplary embodiment. In one arrangement, control panel 30 includes a first switch which is used to activate or set the electronic sensors, a second switch on control panel 30 locks the sensors in an on or off position depending upon which players paid the ante for the switch hands option, and a third switch on control panel 30 clears the sensors after a Blackjack hand is finished. The table may also have attached to it a card reader device which permits the dealer to read his or her hole card in order to determine if the dealer has a blackjack.

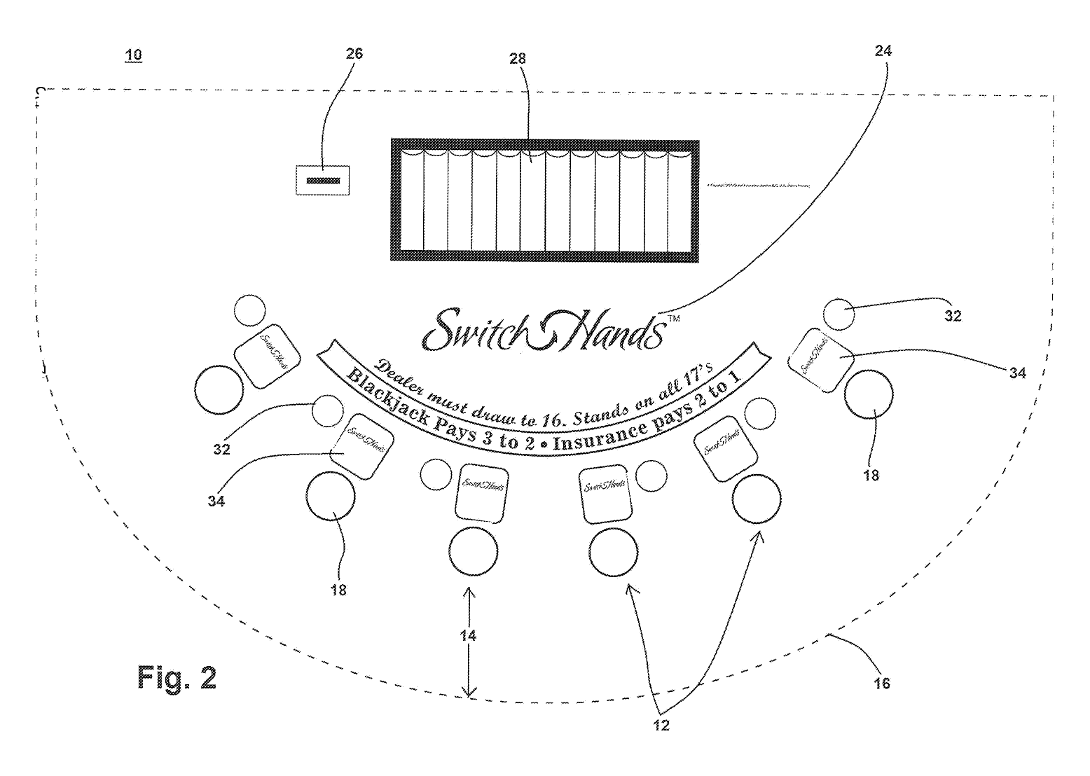

FIG. 2 illustrates another exemplary embodiment of the game layout or skin 10 for playing the game of the invention. As illustrated, game layout 10 in FIG. 2 similarly includes a plurality of player stations 12 each having a betting circle 18 where the player places his or her standard Blackjack wager. In addition, a designated ante fee area 32 is provided where the player places an ante fee in order to be eligible to receive a second or replacement hand in accordance with the method of play of the invention detailed below. The embodiment shown in FIG. 2 does not include the electronic indicator means in the ante payment area 32. In certain embodiments, the ante or stake for being eligible to receive a second or replacement hand is indicated in the designated area 32, such as “$1 for every $5 bet made”. However, it will be understood that the ante can be modified to suit a particular casino's preferences. In one embodiment, the amount of the ante is based on a percentage of the wager made by the player in betting circle 18, such as indicated above, for example, twenty percent. In other embodiments, the amount of the ante may be determined on another basis such as a percentage of the table limits. Positioned next to ante payment area 32 is a second or replacement hand card area 34, in which the dealer places the second or replacement hand cards during game play. In particular, the ante payment area 32 in the player stations 12 on the lefthand side of the game layout as oriented in FIG. 2 is positioned to the left of the second or replacement card area 34, while the ante payment area 32 in the player stations 12 on the righthand side of the game layout is positioned to the right of the second or replacement hand card area 34. Such arrangement is advantageous both to the players and casino, as lefthanded players will tend to sit at the player stations to the left, and righthanded players will tend to sit at the player stations to the right. Thus, when lefthanded players move their bets into ante payment area 32, which they will tend to do using their left hand, the players wrist and forearm will not pass over betting circle 18 or replacement card area 34, leaving such areas in clear view of the overhead surveillance system at all times. Similarly, for righthanded players who will tend to move their bets into ante payment area 32 using their right hand, the players wrist and forearm will not pass over betting circle 18 or replacement card area 34, also leaving such areas in clear view of the overhead surveillance system at all times.

According to a first method of play of the Blackjack game variant of the present invention, the game shall be played with a plurality of decks of cards, preferably not less than six decks nor more than eight decks, which are placed in a shoe dealing device. The point values of the cards contained in each deck shall be according to conventional Blackjack rules, and except where indicated standard Blackjack rules are followed. Prior to the first card being dealt, each player at a player station 12 shall make a blackjack wager which shall equal or exceed the posted minimum wager for the table. In addition, the present game includes a second substitute or replacement hand feature, whereby the player can optionally replace his or her first hand dealt during game play with the substitute or replacement hand. In one embodiment, whether or not a player elects to play or be eligible to replace his or her first hand with a replacement hand is optional, and payment of an ante fee is required for the player to be accorded this option. Players electing to be eligible to switch their first hand with a second replacement hand shall pay the required ante fee for the game by placing this fee in the ante fee area 20 of his or her player station. In one embodiment, the ante fee shall total $1 for each $5 or any portion thereof bet. The ante and all wagers excepting an insurance wager, a double-down wager, or a wager on split pairs shall be placed prior to the first card being dealt for each round of play.

In another embodiment, the ante payment is mandatory. On those tables designated by the casino, players shall be required to make an ante payment in ante fee area 20 in FIG. 1 or ante payment area 32 in FIG. 2. In one embodiment, this payment shall be 20% of the wager or one dollar for every five dollars bet. On tables where the ante payment is mandatory, each player will have the option to replacement his or her initial or original Blackjack hand with a replacement Blackjack hand. Whether or not the ante payment is mandatory or optional, the ante is paid before any cards are dealt.

In embodiments where the opportunity to be eligible to replace a first Blackjack hand with a second replacement Blackjack hand is optional, each player at the different player stations 12 makes this decision individually, such that some players may elect to be eligible to receive a replacement hand by paying the ante fee, and some players may not in which case no ante fee is paid. All wagers, including the replacement hand optional ante fee, shall be made by placing gaming chips or plaques and, if applicable, a match play coupon on the appropriate betting areas of the table layout. A verbal wager accompanied by cash may be accepted, provided it is confirmed by the dealer and casino supervisor, and that such cash is expeditiously converted into gaming chips or plaques. Once the first card of any round of play has been removed from the shoe by the dealer, no player shall make, alter, remove, or otherwise handle any wager that has been made until a decision has been rendered and implemented with respect to that wager, except as may be permitted by specific casino rules.

After all initial wagers and any ante fees have been made, and the dealer has signaled no more wagers, the dealer shall initiate play. Starting with the player immediately to the dealer's left and proceeding clockwise around the table, the dealer shall deal one replacement card face downward to each player who paid the ante fee, followed by dealing a second replacement card face downward to each player who paid the ante fee. Where the ante payment is mandatory, the dealer will deal a replacement hand to each player, while where the ante payment is optional, the dealer will deal a replacement hand only to those players who paid the additional ante. The dealer shall then deal one original Blackjack hand card face upwards to each player making a blackjack wager, and also to the dealer, followed by dealing a second original Blackjack hand card face upwards to each player and one card face downward to the dealer. The dealer shall also collect all ante fees. In one embodiment, the ante fees are collected beginning with the participating player immediately to the dealer's right and continuing in a counter-clockwise direction. All players who have paid the ante fee whether or not the fee is mandatory or optional shall receive a set of two replacement cards which are placed faced down in the designated area of the player station in prior to the player making a decision as to whether or not to continue play using the first original Blackjack hand cards or replacement hand cards. In the embodiment of FIG. 1 the replacement cards may be placed face down in area 20, while in the embodiment of FIG. 2 the replacement cards are placed face down in designated area 34. Alternatively, the dealer may deal each player and himself or herself two cards in order according to conventional Blackjack rules, and then for those players who have paid the ante fee in area 20, the ante fee is collected and the dealer shall deal these players two additional cards which are placed face down on or adjacent area 20.

After the playing cards have been dealt and ante fees collected as described above, starting with the player eligible to substitute or replace his or her original hand with the already dealt replacement hand immediately to the dealer's left and continuing clockwise around the table, the dealer will ask each eligible player in turn to choose if he or she wants to discard the original hand and play the replacement hand. Players shall indicate to the dealer whether they want to play the original two card Blackjack hand or the replacement Blackjack hand, in some cases using appropriate hand signals in accordance with casino custom or policy. For each player choosing to play the replacement hand, the dealer shall remove the two cards of the original hand, placing them in the discard rack, and turn over the two face-down cards forming the replacement hand at each player position. For those players choosing to play their original hand, the dealer removes the face-down cards or replacement hand without turning them over, and places them unseen by any of the players in the discard rack. In an embodiment, for those players who have paid the ante and who have a blackjack showing on their two original hand cards, the dealer shall remove those players' face-down or replacement hand cards and slide the players' blackjack hands into a designated area such as ante area 20 or area 34 in FIG. 2 which shall designate the players' right to receive a 2 to 1 payout for suited or colored blackjacks and a 1 to 2 payout for the Dealer—Players bonus for the tie on blackjack, not a push as in standard blackjack or any other variant of the game.

If the dealer's first card is an ace, king, queen, jack or 10, in one embodiment the dealer shall, after offering an insurance wager or even money in accordance with appropriate law or rules, determine whether the hole card will give the dealer a Blackjack. The dealer shall insert the hole card into a card reader device by moving the card face down on the layout without exposing it to anyone at the table, including the dealer. If the dealer has a Blackjack, in one embodiment additional cards may not be dealt and each player's Blackjack wager and insurance wagers, if applicable, shall be settled. After this procedure is completed, if necessary, the dealer shall start with the player closest to the dealer's left and continue around the table in a clockwise direction and if the player has Blackjack and the dealer's up card is a 2, 3, 4, 5, 6, 7, 8 or 9, the dealer shall announce and pay the Blackjack and remove the player's cards. Players who have paid the replacement card ante shall be paid at the odds of 2 to 1 for colored or suited blackjacks, otherwise they shall be paid at the odds of 3 to 2. If the player has Blackjack and the dealer's up card is an ace, king, queen, jack or 10 but the dealer's hole card will not give the dealer a Blackjack, the dealer shall announce the player's

Blackjack but may not make a payment nor remove any cards until all other cards are dealt to the players and the dealer reveals the hole card. If the player does not have

Blackjack, the player shall indicate whether he wishes to double down as permitted, split pairs as permitted, stand or draw additional cards. As each player indicates his decision, the dealer shall deal face upwards whatever additional cards are necessary to effectuate the player's decision. A player may elect to draw additional cards whenever his or her point count total is less than 21, except that a player having Blackjack or a hard or soft total of 21 may not draw additional cards, and a player electing to make a Double Down Wager may draw only one additional card.

After the decisions of all players have been implemented and all additional cards have been dealt, the dealer shall turn the hole card face up. Any additional cards required to be dealt to the hand of the dealer shall be dealt face upwards. The dealer shall announce the dealer's total point count after each additional card is dealt. Unless the dealer has blackjack, the dealer shall draw additional cards until he has a hard or soft total of 17, 18, 19, 20 or 21. A dealer shall draw no additional cards to his hand, regardless of the point count, if decisions have been made on all players' hands and the point count of the dealer's hand will not have an effect on the outcome of the round of play. After all additional cards have been dealt to the players and the dealer, the dealer shall, starting with the player closest to the dealer's right and continuing around the table in a counterclockwise direction, settle the remaining wagers by collecting all losing wagers and paying all winning wagers.

A player shall win the Blackjack wager and be paid in accordance with applicable payout odds if the total point count of the player's hand is 21 or less and the total point count of the dealer's hand is in excess of 21, if the total point count of the player's hand exceeds the total point count of the dealer's hand without exceeding 21, or if the player has a Blackjack and the dealer's hand has a total point count of 21 in more than two cards. A Blackjack wager shall tie and be returned to the player if the total point count of the player's hand is the same as the dealer's. A player's Blackjack wager shall be lost if the dealer has a Blackjack and the player's hand has a total point count of 21 in more than two cards. The dealer shall collect all losing wagers and pay off all winning wagers in accordance applicable procedures, such as either by collecting all losing wagers and then pay off all winning wagers, or paying off all winning wagers and collecting all losing wagers beginning with the player immediately to the dealer's right and continuing around the table in a counterclockwise direction. The dealer shall place any losing wagers directly into the table inventory and may not pay off any winning wagers by using value chips collected from a losing wager. After all wagers have been settled, the dealer shall remove all remaining cards from the table and place them in the discard rack in a manner that permits the reconstruction of each hand in the event of a question or dispute. Except as may be allowed by rule or regulations, players and spectators may not handle, remove or alter any cards used to play Blackjack.

In embodiments where surrender is allowed, after the first two cards are dealt to the player, the player may elect to discontinue play on his or her hand for that round by surrendering one-half of his or her wager. All decisions to surrender shall be made prior to the player indicating whether he or she wishes to double down as permitted, split pairs as permitted, stand or draw. If the first card dealt to the dealer is not an ace or ten value card, the dealer shall immediately collect ½ of the wager and return ½ to the player. If the first card dealt to the dealer is an ace or ten value card, the dealer will place the player's wager on top of the player's cards. When the dealer's second card is revealed, the hand will be settled by immediately collecting the entire wager if the dealer has Blackjack or collecting ½ of the wager and returning ½ of the wager to the player if the dealer does not have Blackjack. If the player has made an insurance wager and then elects to surrender, each wager will be settled separately in accordance with casino rules and regulations.

In one embodiment, for players who have not exchanged a replacement hand for an original hand, the casino shall pay each winning Blackjack wager at odds of 1 to 1 with the exception of “blackjack” which shall be paid at odds of 3 to 2. For players who have exchanged a replacement hand for an original hand, the casino shall pay each winning blackjack wager at odds of 1 to 1, with the exception of Blackjack at odds of 2 to 1 for suited blackjacks; at odds of 2 to 1 for same color blackjacks; and at odds of 3 to 2 for all other blackjacks. The casino shall pay out winning insurance wagers at odds of 2 to 1. In another embodiment, the payment of a replacement card ante is at the discretion of the casino operator, in which case the game rules may be otherwise modified in order maintain the inherent house edge or statistical advantage to the casino built into a game.

In one embodiment, players are dealt two face-ups cards, and two additional face-down cards whereby such player can choose to play either the two face-up cards or discard both face-up cards and play the two unseen face-down cards. Non-played face-down cards are not turned over and are placed unseen in the discard rack. Otherwise, standard house Blackjack rules apply. The game apparatus and method of the present invention affords players several advantages, including an increased chance of winning, and a decreased chance of busting. Players are paid 2 to 1 for colored or suited blackjacks, and the option for surrender is rendered obsolete. Casino operators also benefit from the present game and method for several reasons. In particular, the present game hinders or eliminates card counting, since as many as twelve cards per game are never seen by the players. This feature is a significant detriment to professional card counters and will discourage this type of player from playing the present game. In addition, the house collects the ante fee, typically at least 20% of the basic wager, whether or not the switch option is used by a player. Further, the hands played per hour is nearly the same as standard Blackjack, both the dealer and player learning curves are relatively small since the game substantially follows standard Blackjack rules, and standard house rules of each casino can be applied to the game. In addition, in a preferred method of play there are no pushes on dealer vs. player play on any Blackjack hands. In case of a tie between the dealer and player, the house will pay the player the payout of 1 to 2 of the player's wager.

Perfect strategy indicates that players should discard their two face-up cards 64% of the time to increase their probability of winning in Blackjack. The present game allows players to do so and gives positive reinforcement to the player, but at the same time the “ante” which always belongs to the house and is collected before hands are played out, increases the casino's edge by less than 1%.

In a preferred embodiment, players are not afforded the opportunity to switch or exchange either one card or both cards. Rather, either the players are required to keep and play their first or original hand, or the entire hand is replaced with the second or replacement hand. In addition, the second or replacement hands are dealt face-down, so that they are not visible to the players. It has been found unexpectedly that the presently described game rules or guidelines provide a significantly improved Blackjack game as compared to prior art Blackjack games having a side bet feature or the opportunity to exchange or otherwise improves one's Blackjack hand, with an important advantage to the casino being the provision of a Blackjack game that follows most conventional Blackjack rules while also inhibiting card counting.

In other embodiment, the variant Blackjack game of the invention is able to accommodate bonus bets, whether they are side-bets or additional wagering opportunities. An example of a bonus payout that can be readily adapted for use in connection with the game is the provision of a bonus payout for a player matching the dealers suit and/or the exact face card and ace of the same suit, for player vs. dealer blackjacks ties pays the bonus of 4 to 1. As another example, when two or more players match the dealers blackjack on the same deal, the two players match bonus pays 10 to 1. If three players match the bonus pays 20 to 1, if four players match the bonus pays 40 to 1, if five players match the bonus pays 80 to 1, and if six players match the bonus pays 600 to 1. Other Bonus side-bets are also possible. Preferably, the dealer is required to physically handle and place the player's winning blackjack hands into the bonus pay areas on the table.

Depending upon the legal jurisdiction governing the gaming establishment, rules may mandate that the house offer players' the option to pay the ante and play switch hands, or elect to play regular blackjack and forfeit the features of playing switch hands. The present game and method of play are readily adaptable to both scenarios without requiring any revisions to the game layout or other gaming requirements.

In additional embodiments, the card game of the present invention can be played through electronic or computerized formats in accordance with a computer program operable to provide the desired game environment. For example, the card game may be played on or through a computer in an embodiment of the invention. In such illustrative embodiment, the game may comprise either networked and unnetworked versions of gameplay. In the unnetworked version, the game may include a single player mode, where the single player plays against himself, as well as against a dealer either alone or with a plurality of computerized Artificial Intelligence (AI) player(s), which simulate card playing together against the dealer. In additional embodiments, the networked version of the game is similar to the unnetworked version described above, except the player can connect with other players through the internet using a gaming or social media account to identify himself or herself. In this embodiment, the use of AI(s) are not necessary for gameplay, as the player can connect with other human players, although such Al feature is still an envisioned element of the invention.

In additional embodiments, the game could be played on other types of electronic devices other than a computer. For example, the game may be played on a smartphone, a personal digital assistant (PDA), a tablet computer, or other mobile device and the like. It can additionally be played through a casino type game such as a slot machine type gaming console hooked up to a LCD/LED screen, or like television screen. It could also be played on an electronic device which has been specifically adapted for the game, like a handheld game playing device. It should also be mentioned that embodiments of the invention include the both the unnetworked and networked versions of the game to be playable on the devices mentioned above, with the networked version being made possible if/when such devices are capable of internet connectivity. It will be recognized therefore that a computer program written to facilitate the play of the present invention may be of a variety of types and include a variety of elements, such as means of representing the playing environment, including the playing surface, representations of the playing cards, representations of dealing of the cards, representations of the time, means by which a player may communicate an intention to accept a “hit” or “stand” or exchange a first hand of cards for a replacement hand in accordance with the invention. In other embodiments, the game can be adapted for play as a studio game show for possible television broadcast.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

We claim:

1. A method of playing a variant blackjack game a comprising the steps of:
a. receiving a first player wager;
b. receiving a first player ante for which a player is to be dealt a replacement hand;
c. dealing a replacement hand comprising two face down cards to a player;
d. dealing an initial hand to said player;
e. dealing an initial hand to a dealer comprising a face up card and a face down card;
f. permitting the player the opportunity to substitute the initial hand with the replacement hand, and if the initial hand is not substituted the dealer discarding the replacement hand unseen by the players; and
g. resolving the blackjack game using either the player's initial hand or replacement hand according to predetermined rules.)

2. The method of claim 1 wherein payment of the ante by a player is mandatory.

3. The method of claim 1 wherein the initial hand dealt to a player is comprised of two face up cards.

4. The method of claim 1 additionally comprising a game layout including a plurality of player stations each including an ante payment area and replacement card area.

5. The method of claim 4 in which when in step (f) a player substitutes the replacement hand for an initial hand, and the replacement hand results in blackjack, the replacement hand in placed in the replacement card area.

6. The method of claim 1 in which blackjack pays 3 to 2 for the initial hand, and blackjack pays 2 to 1 for the replacement hand.

7. The method of claim 6 in which wherein the ante is a percentage of the wager.

8. The method of claim 6 in which the ante is a fixed fee substantially less than the amount of the wager.

9. The method of claim 1 additionally comprising the initial step of executing the instructions on an electronic processing unit on a computer:

10. An electronically implemented method of playing a blackjack game against a gaming establishment comprising the steps of:
accepting player wagers;
accepting antes which belong to the house;
displaying two player cards face up, two cards of a simulated dealer, and two cards face down if players have paid the ante;
permitting those players who have paid the ante to elect to play using the two face up cards or the two face down cards, and discarding either the two face up cards or two face down cards unseen; and
resolving the blackjack game using either the player's two face up card or two face down cards according to predetermined rules.

11. The machine of claim 10 wherein the ante is automatically deducted from stored and displayed credits.

12. A blackjack variant game table layout comprising:
a. a plurality of player betting stations, each including a first betting circle, an ante payment area, and a replacement card area,
b. whereby in one or more of said player betting stations situated on the lefthand side of the game table layout the ante payment area is positioned to the left of the first betting circle and replacement card area, and in one or more of said player betting stations situated on the righthand side of the game table layout the ante payment area is positioned to the right of the first betting circle and replacement card area.
